(19) United States
(12) Patent Application Publication
(10) Pub. No.: US 2018/0290332 A1
(43) Pub. Date: Oct. 11, 2018

(54) PORTABLE MOLDING APPARATUSES AND METHODS OF FORMING OBJECTS USING PORTABLE MOLDING APPARATUSES

(71) Applicant: Outreach International, Independence, MO (US)

(72) Inventors: Steven L. Ross, Pittsburgh, PA (US); Lucas Andrews, Independence Township, PA (US)

(73) Assignee: Outreach International, Independence, MO (US)

(21) Appl. No.: 15/948,312

(22) Filed: Apr. 9, 2018

Related U.S. Application Data
(60) Provisional application No. 62/482,884, filed on Apr. 7, 2017.

(51) Int. Cl. B28B 7/10; E04C 1/00; B62B 3/00; B62B 3/02; B28B 7/28; B28B 17/00; B28B 7/00

(52) U.S. Cl. CPC B28B 7/10; E04C 1/00; B62B 3/002; E04B 2/08; B28B 7/28; B28B 17/00; B28B 7/0002; B62B 3/02

(57) ABSTRACT

A portable molding apparatus includes a lower portion including an extension device that is movable between an extended position and a retracted position, and a platform coupled to the extension device, an upper portion positioned above the lower portion, the upper portion including a base, a plurality of walls extending upward from the base, the plurality of walls defining a cavity bounded by the plurality of walls and the base, and a lid positioned over the cavity, a core positioned within the cavity defined by the plurality of walls, and a pin coupled to the core and extending downward from the core through the base, where the pin is spaced apart from the platform when the extension device is in the retracted position and the pin is engaged with the platform when the extension device is in the extended position.

### CROSS-REFERENCE TO RELATED APPLICATIONS

This application claims priority to U.S. Provisional Patent Application Ser. No. 62/482,884, filed Apr. 7, 2017 and entitled “Portable Molding Apparatuses and Methods of Forming Objects Using Portable Molding Apparatuses,” the contents of which is incorporated herein in its entirety.

### TECHNICAL FIELD

The present specification generally relates to portable molding apparatuses and methods for forming objects, and more specifically, to portable molding apparatuses used for forming construction blocks and methods of forming construction blocks using the portable molding apparatuses.

### BACKGROUND

In many parts of the world, such as in underdeveloped countries, significant portions of the population may reside in simple structures that do not provide adequate protection from the elements and/or that may be particularly susceptible to calamities, such as extreme weather or earthquakes. While many advances have been made in building technology, providing adequate and affordable housing remains a challenge. Conventional low-cost housing solutions may involve constructing structures out of modular components, such as concrete blocks or the like. The modular components may be manufactured, and then shipped to a building site for assembly into a housing structure. However, in some instances, the building site may be far away from the manufacturing site, or may otherwise be costly and difficult to reach, as roads and infrastructure in underdeveloped countries may not be adequate to carry the modular components.

Other conventional low-cost housing solutions may involve transporting machinery and building apparatuses to building sites, and fabricating the modular components on-site. Existing apparatuses are bulky, cannot be readily transported, require multiple users to operate, and/or do not efficiently create construction blocks at or near a construction site.

### SUMMARY

In one embodiment, a portable molding apparatus includes a lower portion including an extension device that is movable between an extended position and a retracted position, and a platform coupled to the extension device, an upper portion positioned above the lower portion, the upper portion including a base, a plurality of walls extending upward from the base, the plurality of walls defining a cavity bounded by the plurality of walls and the base, and a lid positioned over the cavity, a core positioned within the cavity defined by the plurality of walls, and a pin coupled to the core and extending downward from the core through the base, where the pin is spaced apart from the platform when the extension device is in the retracted position and the pin is engaged with the platform when the extension device is in the extended position.

In another embodiment, a portable molding apparatus includes a lower portion including an extension device that is movable between an extended position and a retracted position, and a platform coupled to the extension device, an upper portion positioned above the lower portion, the upper portion including a base, and a plurality of walls extending upward from the base, the plurality of walls defining a cavity bounded by the plurality of walls and the base, where the base is engaged with the platform when the extension device is in the extended position, and the base is disengaged from the platform when the extension device is in the retracted position.

In yet another embodiment, a portable molding apparatus includes a lower portion including an extension device that is movable between an extended position and a retracted position, a lower platform coupled to the extension device, and an upper platform positioned above the lower platform and coupled to the lower platform, an upper portion positioned above the lower portion, the upper portion including a base, a plurality of walls extending upward from the base, the plurality of walls defining a cavity bounded by the plurality of walls and the base, and a lid positioned over the cavity, a core positioned within the cavity defined by the plurality of walls, a pin extending downward through from the base, and a retention member coupled to the pin and positioned between the lower platform and the upper platform, where the retention member is spaced apart from the lower platform when the extension device is in the retracted position and the retention member is engaged with the lower platform when the extension device is in the extended position.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side view of a portable molding apparatus, according to one or more embodiments shown and described herein;

FIG. 2 schematically depicts a top cross-sectional view of the portable molding apparatus of FIG. 1, according to one or more embodiments shown and described herein;

FIG. 3A schematically depicts a side view of a lid of the portable molding apparatus of FIG. 1, according to one or more embodiments shown and described herein;

FIG. 3B schematically depicts a bottom view of the lid of FIG. 3A, according to one or more embodiments shown and described herein;

FIG. 4 schematically depicts the portable molding apparatus of FIG. 1 being filled with a material, according to one or more embodiments shown and described herein;

FIG. 5 schematically depicts placement of the lid of FIG. 3A onto the portable molding apparatus, according to one or more embodiments shown and described herein;

FIG. 6 schematically depicts the portable molding apparatus of FIG. 5 with the lid fixed in place, according to one or more embodiments shown and described herein;

FIG. 7 schematically depicts the portable molding apparatus of FIG. 6 having the lid removed after formation of an object within the portable molding apparatus, according to one or more embodiments shown and described herein;

FIG. 8 schematically depicts the portable molding apparatus of FIG. 7 with the molded object being removed from the portable molding apparatus, according to one or more embodiments shown and described herein;

FIG. 9 schematically depicts the portable molding apparatus of FIG. 8 with the molded object fully removed, according to one or more embodiments shown and described herein;

FIG. 10 schematically depicts another portable molding apparatus, according to one or more embodiments shown and described herein;

FIG. 11 schematically depicts the portable molding apparatus of FIG. 10 with the lid being removed from the portable molding apparatus, according to one or more embodiments shown and described herein;

FIG. 12 schematically depicts the portable molding apparatus of FIG. 11 with a molded object being removed from the portable molding apparatus, according to one or more embodiments shown and described herein;

FIG. 13 schematically depicts the portable molding apparatus of FIG. 11 with pins of the portable molding apparatus being returned to an initial position, according to one or more embodiments shown and described herein;

FIG. 14 schematically depicts a flowchart of an exemplary method for forming a block using a portable molding apparatus, according to one or more embodiments shown and described herein;

FIG. 15 schematically depicts an illustrative construction block formed from a portable molding apparatus according to one or more embodiments shown and described herein; and

FIG. 16 schematically depicts an illustrative plurality of coupled construction blocks according to one or more embodiments shown and described herein.

### DETAILED DESCRIPTION

In developing regions around the world, there is a shortage of affordable and effective housing. Conventional housing options are typically temporary and vulnerable to calamities, such as severe weather, earthquakes, and the like. Many houses are shared by multiple families, and many houses are occupied unfinished. Some houses are constructed of concrete, but concrete typically is expensive and requires skilled labor to construct. As a result, insulated construction forms (ICF) have been implemented in construction to help communities to address their issues by providing an option for comfortable, resilient, and affordable housing while at the same time creating a new income-generating trade relating to productions of the ICF blocks.

The ICF blocks are generally constructed of a liquid compound, a foam compound, or the like. The compound is deposited into a cavity (e.g., a form or the like) and allowed to cure such that the compound takes the shape of the cavity in which it is deposited. For example, a two part liquid polyurethane foam (i.e., two separate components that are combined together for curing) may be deposited into a cavity and allowed to cure such that the cavity forms the ICF block in the desired shape. While ICF blocks and two part liquid polyurethane foam are described herein, it should be understood that these are nonlimiting examples provided for illustrative purposes only.

The embodiments described herein are generally directed to a portable molding apparatus that is configured for forming objects such as construction blocks, as well as methods for forming objects using the portable molding apparatus. The portable molding apparatus can be movable to a site where the formed objects are needed, such as a construction site or the like, by one or two individuals without the help of large machinery. As such, the portable molding apparatus described herein can be used at a construction site or the like to form construction blocks, which reduces shipping costs associated with forming construction blocks at a central location and shipping the formed blocks to various construction sites. As will be described in greater detail herein, the portable apparatus includes a cavity that is particularly shaped and sized to hold and form a deformable material while it cures, and then facilitate removal of the material from the cavity after formation.

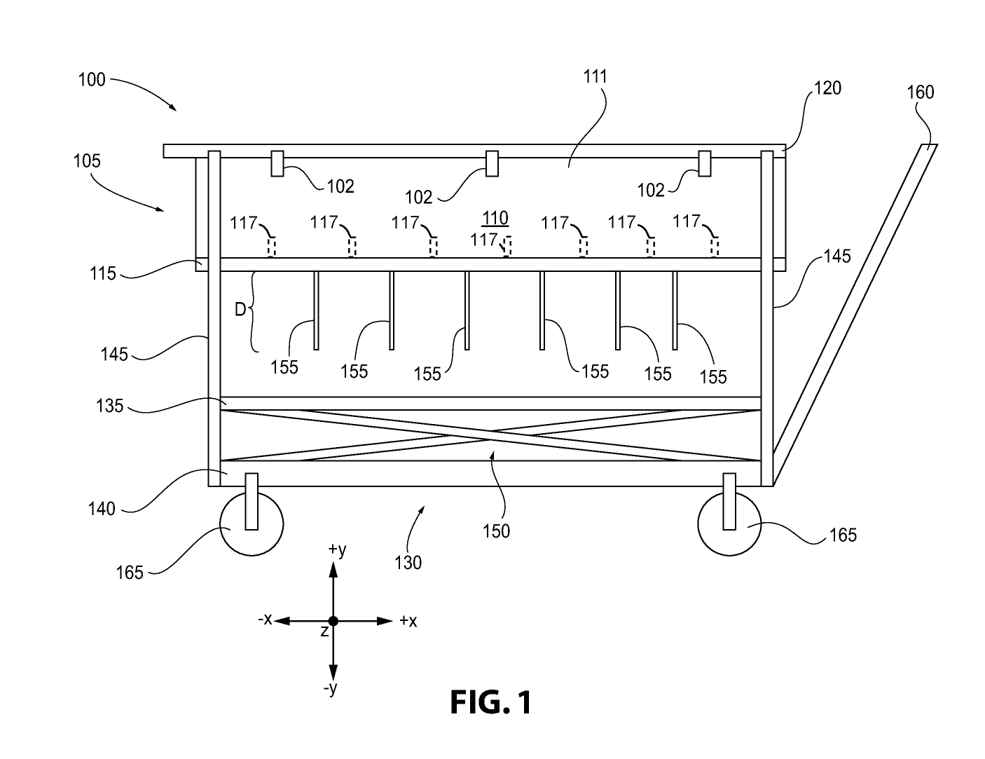

FIG. 1 depicts a portable molding apparatus 100, according to various embodiments. The portable molding apparatus 100 includes an upper portion 105 and a lower portion 130 positioned below the upper portion 105. In some embodiments, the portable molding apparatus 100 may optionally include wheels 165 or the like to facilitate portability thereof. That is, the wheels 165 may be used such that one or more users may move the portable molding apparatus 100 without the need for large machinery, such as a crane, hydraulic or pneumatic lift systems, motorized vehicles, or the like. The wheels 165 may be coupled to a portion of the portable molding apparatus 100, such as, for example, the lower portion 130 of the portable molding apparatus 100. In other embodiments, the portable molding apparatus 100 may not include the wheels 165, and be freestanding or mounted to an external component for transport, such as a pallet or the like.

The upper portion 105 of the portable molding apparatus 100 may generally be configured to hold and shape a moldable material. In embodiments, the upper portion 105 includes a container 110 including a plurality of walls 111, a base 115, and a removable lid 120. The container 110 may be constructed of any type of material or combination of materials suitable for molding, such as metal, metal alloys, composites, or the like, and may be formed through any suitable process, such as stamping, casting, forging or the like.

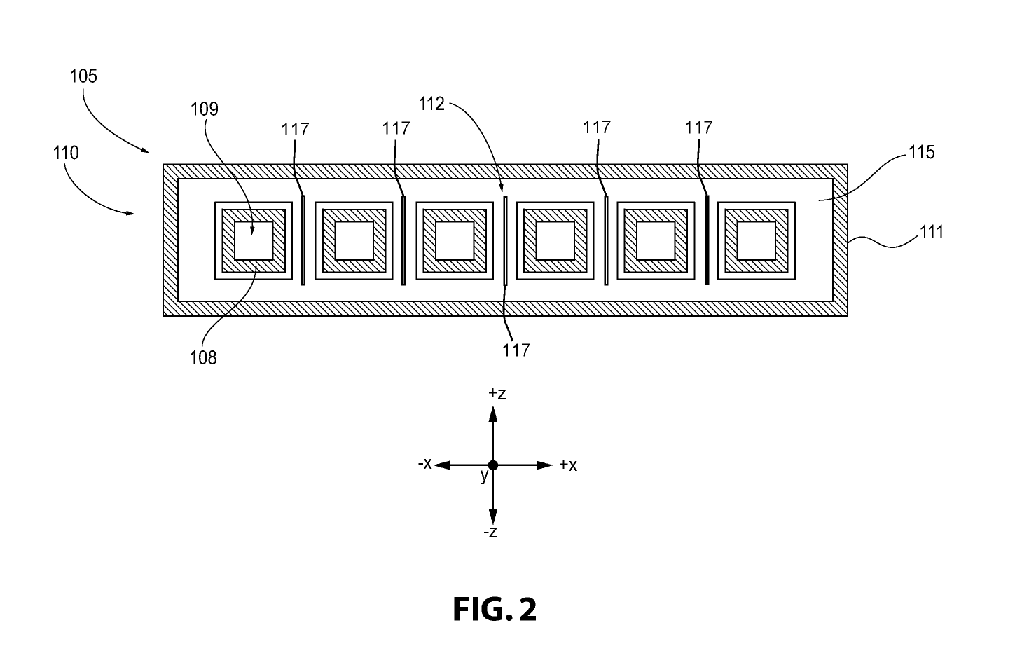

Referring now to FIG. 2, a top view of the container 110 is depicted. The plurality of walls 111 of the container 110 defines a cavity 112 bounded in the z-direction and x-direction of the coordinate axes of FIG. 2 by the plurality of walls 111 and bounded by the base 115 in the y-direction, as depicted. The cavity 112 may contain and shape a moldable material. While in the embodiment depicted in FIG. 2 the plurality of walls 111 form a rectangular-shaped cavity 112, the cavity 112 may be shaped and/or sized in any manner that corresponds to a particular shape and/or size of an object to be formed from the moldable material. For example, any or all of the walls of the plurality of walls 111 and the base 115 may include curved or patterned shapes corresponding to a desired shape of an object to be formed from the moldable material.

In the embodiment depicted in FIG. 2, one or more cores 108 are positioned within the cavity 112 to allow for additional shaping of the moldable material deposited within the cavity 112. For example, when the container 110 is used to form a block, it may be desirable to position the one or more cores 108 in locations where the blocks should contain a void that is shaped and/or sized to receive certain portions of other blocks to couple a plurality of blocks together. In some embodiments, each of the one or more cores 108 may include a void 109 defined within the core 108. The voids 109 may reduce the overall weight of the container 110 as compared to configurations including cores made of a solid construction. Reducing the overall weight of the container 110 may increase the ease with which the container 110 may be transported. The voids 109 may also assist in cooling the interior of the cavity 112. For example and without being bound by theory, ambient air may be positioned within the voids 109 and may absorb thermal energy from the cavity 112 during a curing process, which may assist in maintaining the cavity 112 at an appropriate temperature for curing a block, such as an ICF block. In other embodiments, the one or more cores 108 may be solid.

Each of the one or more cores 108 may be moved up and down (e.g., in the y-direction of the coordinate axes of FIG. 2 as depicted), which may assist in removing a cured molded material, such as a block, from the cavity 112. That is, the one or more cores 108 may be pushed in the up or down directions to cause the cured material to separate from various portions of the container 110 (e.g., the walls 111, the base 115, the one or more cores 108, and/or the like) such that the cured material can be removed from the cavity 112. In some embodiments, each one of the one or more cores 108 may be movable independent of one or more other ones of the one or more cores 108. In other embodiments, all of the one or more cores 108 may be movable together.

In some embodiments, the one or more cores 108 may be movable prior to deposition of the material within the cavity 112, for example in a lateral or longitudinal direction (i.e., in the x-direction or the z-direction of the coordinate axes FIG. 2) to form voids within molded material as desired. In particular, the one or more cores 108 may be movable and then temporarily fixed in a particular position before the material is deposited in the cavity 112.

Referring again to FIG. 1, in some embodiments, the base 115 may be shaped and sized such that it is coupled to an interior of each of the plurality of walls 111. In addition, the base 115 may be coupled to the plurality of walls 111 such that it is movable within the cavity 112 (FIG. 2) when an external force is applied to the base 115. For example, the base may be pushed in an upwards direction (e.g., in the +y direction of the coordinate axes of FIG. 1) into the cavity 112 (FIG. 2) to eject the object from the cavity 112 once it has been formed therein. In other embodiments, the base 115 may be fixed to the container 110 (e.g., the walls 111 of the container 110) such that the base 115 does not move with respect to the plurality of walls 111.

Referring collectively to FIGS. 1 and 2, in some embodiments one or more fins 117 may optionally be coupled to and extend upward from the base 115. The one or more fins 117 may act to form features within the material being cured within the cavity 112. While in the embodiment depicted in FIGS. 1 and 2, the one or more fins 117 are positioned between the cores 108, it should be understood that the one or more fins 117 may positioned at any desired location on the base 115 to form features within the material being cured within the cavity. In some embodiments, the base 115 may include one or more apertures or the like therethrough. The one or more apertures may allow one or more pins 155 coupled to the one or more cores 108 to extend out of the container 110. The apertures may be configured to closely surround the one or more pins 155, utilize seals, and/or the like so as to ensure that the material deposited within the cavity 112 does not leak out of the container 110 through the apertures. In other embodiments, the one or more pins 155 may be coupled to the base 115, such that the pins 155 are not movable with respect to the one or more pins 155.

The removable lid 120 may cover at least a portion of an opening into the cavity 112 and may generally be removed for purposes of depositing the moldable material and/or removing the formed object therein. As such, the removable lid 120 may be shaped and/or sized to sufficiently cover at least a portion of the container 110. For example, the removable lid 120 may extend at least to each of the plurality of walls 111 of the container 110. In some embodiments, the removable lid 120 may be shaped and sized with various features such that the various features in the removable lid 120 are used to form features in the object formed within the container 110.

In some embodiments, various components may be used to ensure a tight seal between the removable lid 120 and the container 110. For example, one or more clamps 102 or the like may be used to clamp the removable lid 120 to the container 110 to ensure that the removable lid 120 is tightly sealed to the container 110. A tight seal may be necessary to ensure that the moldable material is adequately formed by the container 110 and that the moldable material does not overflow out of the container 110.

In some embodiments, the removable lid 120 may be hingedly coupled to the container 110 (e.g., hingedly coupled to one or more of the plurality of walls 111 of the container 110). As such, the removable lid 120 may be able to swing between an open position and a closed position via one or more hinges. Other means of coupling the removable lid 120 to the container 110 are also contemplated.

Referring again to FIG. 1, the container 110 of the portable molding apparatus 100 may be supported on the lower portion 130 by one or more vertical support pieces 145 that extend between the lower portion 130 and the container 110. The one or more vertical support pieces 145 may support the container 110 a distance away from various components of the lower portion 130 to allow movement of various components of the lower portion 130.

The lower portion 130 of the portable molding apparatus 100 includes a base 140 that supports the vertical support pieces 145, a lower platform 135, and an extension device 150. The extension device 150 is positioned between the base 140 and the lower platform 135 and is configured to move between an extended position and a retracted position. FIG. 1 generally depicts the extension device 150 in the retracted position in which the lower platform 135 is located generally near the base 140. When the extension device 150 moves to the extended position, the extension device 150 may push the lower platform 135 upwards (e.g., in the +y direction of the coordinate axes of FIG. 1) away from the base 140.

The extension device 150 may generally be any device that can be movable between extended and retracted positions. While FIG. 1 depicts the extension device 150 as being a scissor-type lift, the extension device 150 may include any suitable configuration to move the lower platform 135 between an extended position and a retracted position. For example, in some embodiments, the extension device 150 may be include a screw, a rack and pinion, a hydraulic lift device, a pneumatic lift device, a pulley-based device, or the like.

The extension device 150 generally supports the lower platform 135 and the lower platform is coupled to the extension device 150. In some embodiments, the lower platform 135 is generally planar and is configured to contact/move the one or more pins 155, as described in greater detail herein. In other embodiments, the lower platform 135 may not be planar; rather the lower platform 135 may be shaped or contoured such that various portions of the lower platform 135 contact particular ones of the one or more pins 155 when the extension device 150 is extended to a particular height, but do not contact other ones of the one or more pins 155.

As described above, the one or more pins 155 are coupled to the one or more cores 108 (FIG. 2) and/or the base 115 and may extend out of the container 110 in a direction generally toward the lower portion 130 of the portable molding apparatus 100. The pins 155 may generally function as an extension of the cores 108 (FIG. 2) so as to allow the cores 108 to be moved in an up/down direction (e.g., generally in the +y/−y directions of the coordinate axes of FIG. 1) to facilitate removal of the material from the container 110 when the lower platform 135 is extended to contact and move the pins 155.

In some embodiments, each one of the one or more pins 155 may correspond to one of the one or more cores 108 (FIG. 2) such that each core 108 (FIG. 2) has a pin 155 extending downward therefrom. For example, in the embodiments depicted in FIGS. 1 and 2, the six cores 108 correspond to the six pins 155, where each of the six cores 108 is coupled to a corresponding one of the six pins 155. However, it should be understood that some cores may have a plurality of pins 155 extending therefrom and/or some cores may have no pins 155 extending therefrom. The one or more pins 155 may be any shape or size, particularly shapes and sizes that are sufficient to push the cores 108, and accordingly a cured object out of the container 110.

In some embodiments, the one or more pins 155 may each extend a particular distance D out of the container 110. The distance D may be such that each of the one or more pins 155 can be contacted by the lower platform 135 and pushed generally upwards (e.g., generally in the +y direction of the coordinate axes of FIG. 1). In some embodiments, the distance D may be the same for each of the one or more pins 155 (i.e., each of the one or more pins 155 extends the same distance out of the container 110). In other embodiments, the distance D may be different for each of the one or more pins 155. That is a certain one of the one or more pins 155 may extend a first distance and a certain one of the one or more pins 155 may extend a second distance, where the first distance and the second distance are not equal. Such a variation in the distance between the one or more pins 155 may allow the cores to be pushed up/down at distances independently of one another from the lower platform 135.

In some embodiments, a biasing member, such as a compression spring or the like, may be positioned on or around each one of the one or more pins 155. The biasing member or biasing members may be positioned between the bottom of the base 115 and the lower platform 135. When the extension device 150 is in the retracted position as shown in FIG. 1, the biasing member or biasing members may act to bias the pins 155 downward (i.e., in the −y-direction of the coordinate axes of FIG. 1).

In some embodiments, the portable molding apparatus 100 may further include a handle 160 coupled to a portion thereof. The handle 160 may facilitate movement of the portable molding apparatus 100 (e.g., to allow a user to push/pull the portable molding apparatus 100) and/or may facilitate extension/retraction of the extension device 150. For example, the handle 160 may be coupled to the extension device 150 and may transmit mechanical force necessary for the purposes of extending or retracting the extension device 150. For example, the handle 160 may act as an extension of a manual pump for extending or retracting the extension device 150 when the extension device 150 is a pneumatic actuator. In some embodiments, the handle 160 may be coupled to the wheels 165 and may be used to steer the portable molding apparatus 100.

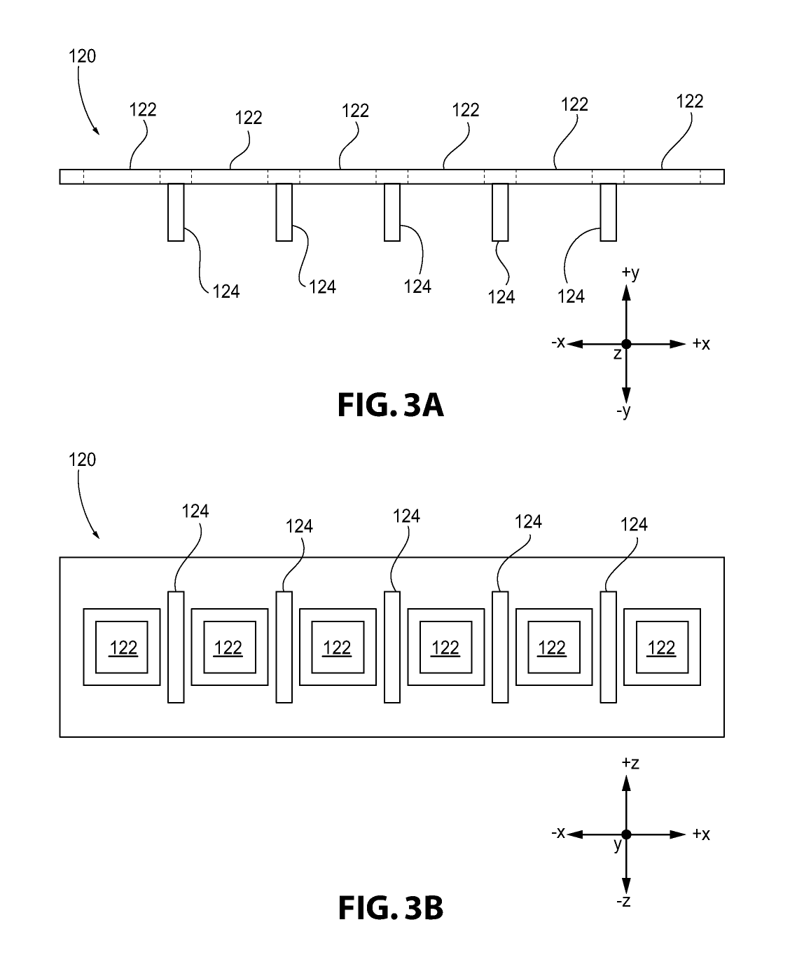

Referring collectively to FIGS. 3A and 3B, a side view and a bottom view of the lid 120 is depicted in isolation. In embodiments, the lid 120 generally includes one or more apertures 122 extending therethrough, and one or more fins 124 extending downward from the lid in the vertical direction (i.e., in the −y-direction of the coordinate axes of FIGS. 3A and 3B). The one or more apertures 122 may assist in cooling material within the cavity 112 (FIG. 2) as the material is cured, and may also allow excess material to exit the cavity 112 (FIG. 2) during the curing process. The one or more apertures 122 may also assist in forming a shapes on the top of blocks formed within the cavity 112 (FIG. 2). The one or more fins 124 may extend downward into the cavity 112 (FIG. 2) when the lid 120 is installed to the container 110 (FIG. 1), and may act to form features within the material being cured within the cavity 112 (FIG. 2).

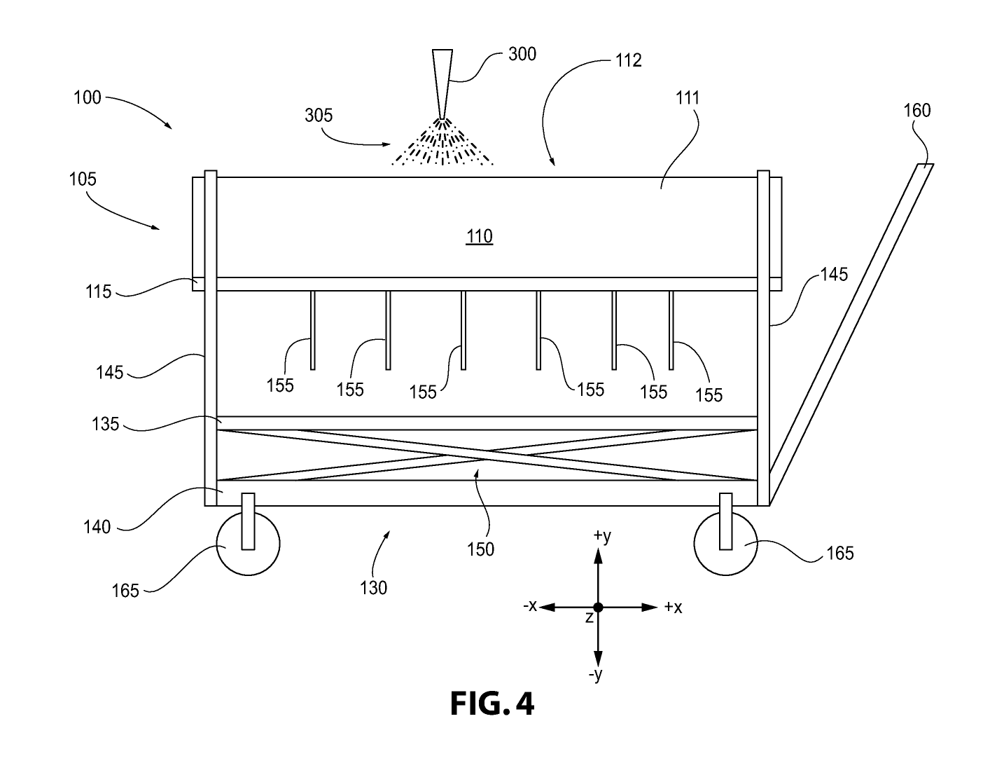

FIGS. 4-9 schematically illustrate a method of using the portable molding apparatus 100 to form an object, such as an ICF block. As shown in FIG. 4, the container 110 may initially be open at a top portion thereof for receiving a material 305 in the cavity 112 (FIG. 2). In the embodiment depicted in FIG. 4, material 305 is deposited within the container 110 via a nozzle 300, however, the material 305 may be deposited within the container in any suitable fashion.

In general, the material 305 may generally be any material, particularly materials that are moldable and can cure to form a hardened object. As such, the material 305 may initially be deposited in liquid form and/or semi-liquid form (e.g., foam) such that the material 305 is easily spread to completely fill the cavity 112 (FIG. 2) defined by the container 110. The material 305 may further be such that it cures after a particular period of time to become the formed object (e.g., a formed ICF block). In some embodiments, the material 305 may expand after it is deposited but before it cures such that it fills the entire cavity 112 defined by the container 110. Illustrative examples of the material 305 include, but are not limited to polyurethane, latex, plant fibers (e.g., cellulose), concrete, and/or the like.

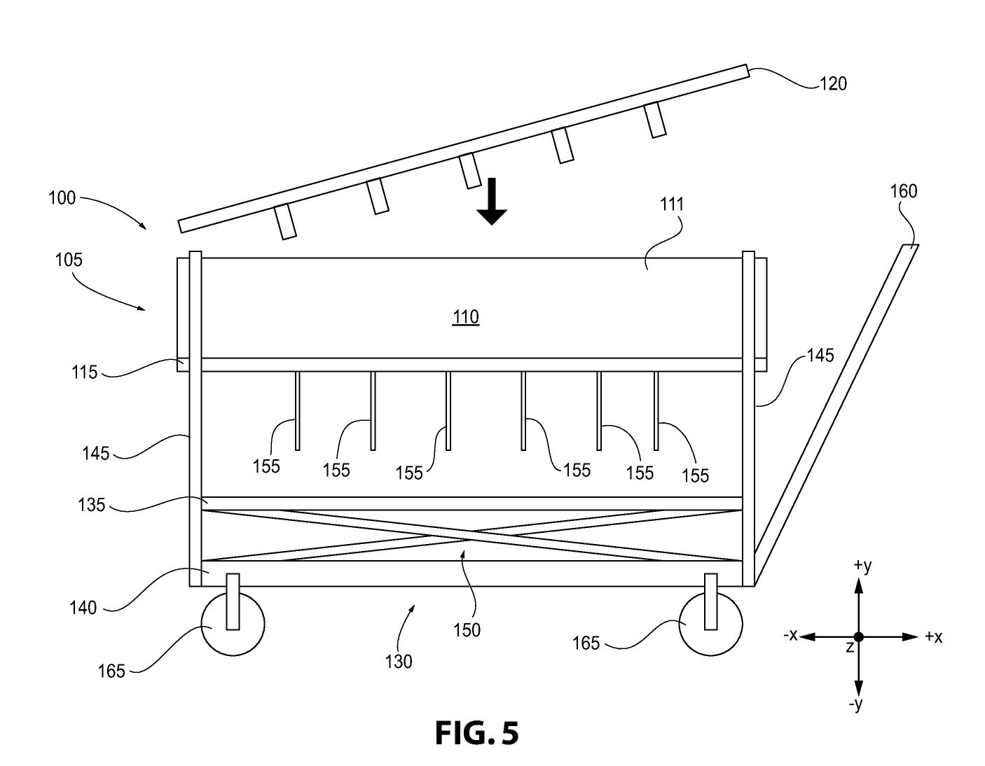

Referring to FIG. 5, once the material 305 is deposited within the cavity 112 (FIG. 2), the removable lid 120 may be deposited on the container 110. In some embodiments, the removable lid 120 may also be tightly sealed to the container 110 via the one or more clamps 102 or other similar device to ensure that the material 305 therein does not leak out of the container 110 while it expands and cures.

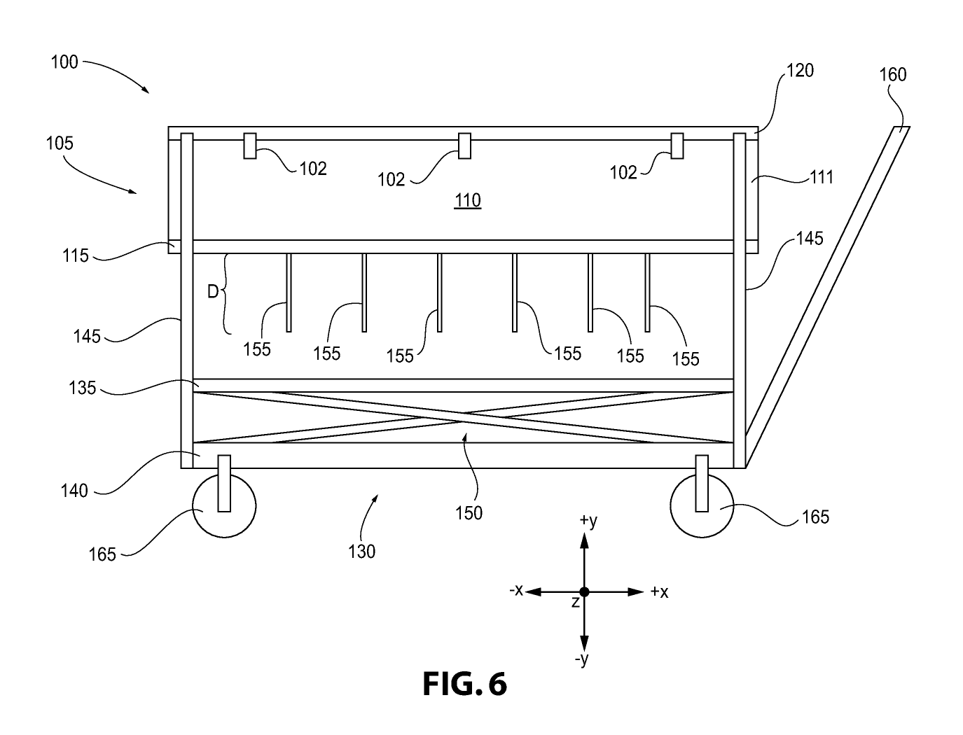

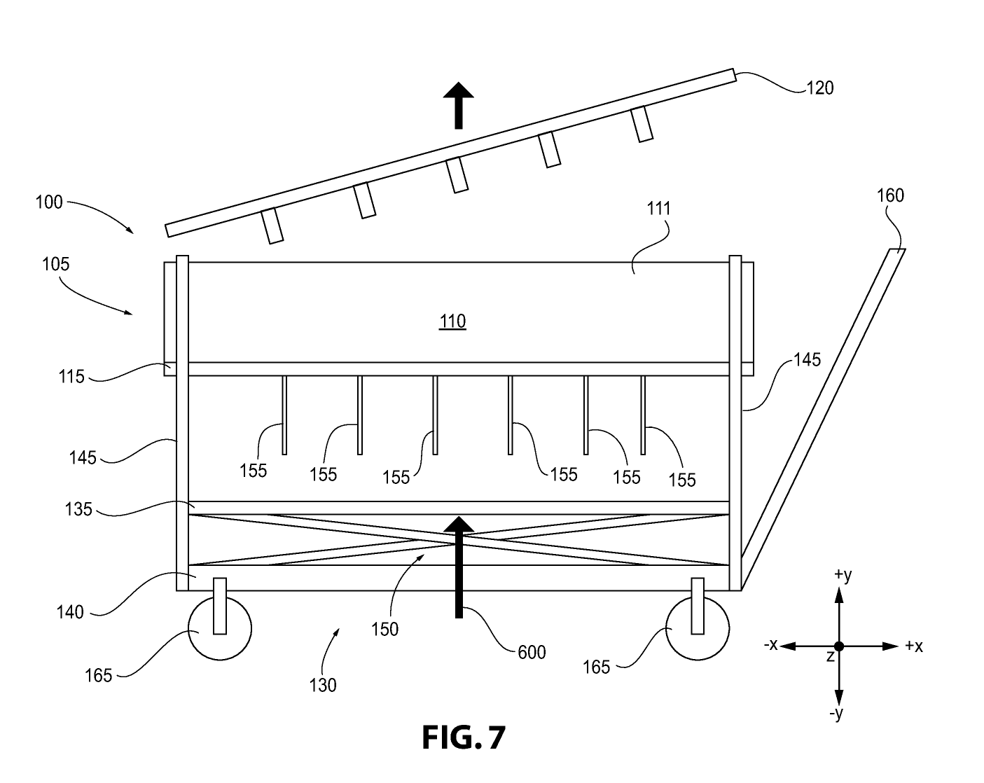

Referring collectively to FIGS. 6 and 7, the material 305 (FIG. 4) may be cured within the container for a period of time, after which (e.g., after the material has been given a sufficient amount of time to cure), the removable lid 120 may be removed. The period of time is not limited by this disclosure, and may be any period of time suitable for curing the material 305 (FIG. 4).

After removing the removable lid 120, the extension device 150 may be moved toward the extended position from the retracted position, thereby causing one or more of the lower platform 135, the one or more pins 155, and/or the base 115 of the container 110 to move in an upward direction (e.g., indicated by the arrow 600) to apply a force to the object within the container 110 such that the object is ejected from the container 110.

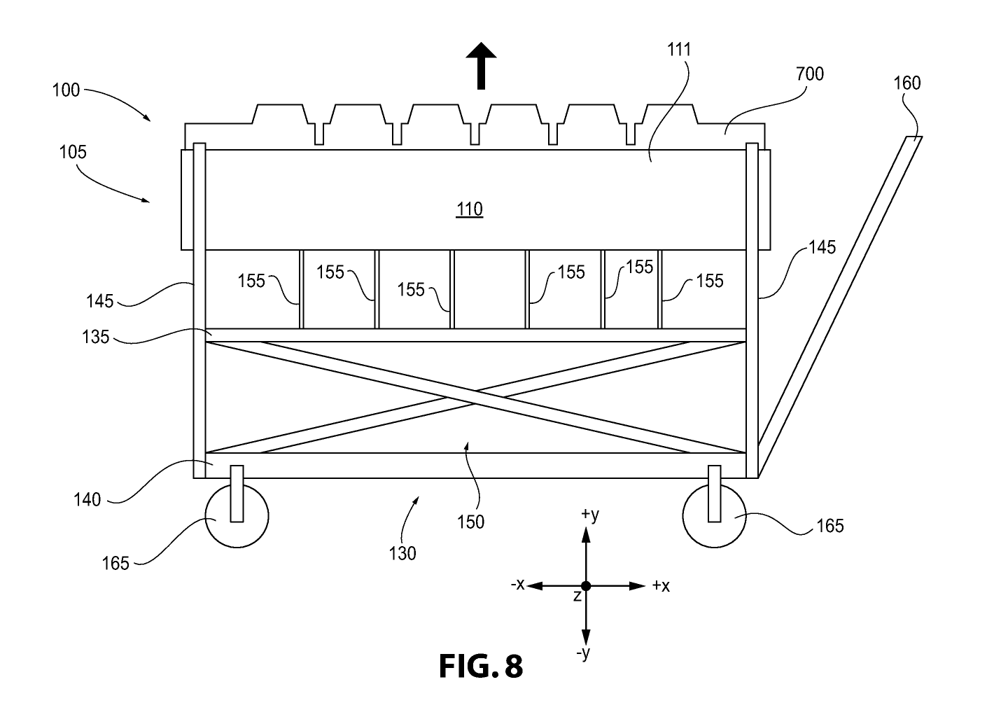

For example and referring to FIG. 8, as the extension device 150 moves upward, the lower platform 135 contacts one or more of the pins 155, pushing the pins 155 upward. As the pins 155 are pushed upward by the extension device 150 (through the lower platform 135), the pins 155 may move the base 115 (FIG. 7) and/or the cores 108 (FIG. 2) upward into the cavity 112 (FIG. 2). As the base 115 (FIG. 7) and/or the cores 108 (FIG. 2) move upward within the cavity 112 (FIG. 2), a formed object 700 (e.g., an ICF block) may be ejected from the container 110. In some embodiments, the lower platform 135, the one or more pins 155, and/or the base 115 of the container 110 may engage each of the one or more cores 108 (FIG. 2) and apply pressure to the one or more cores 108 to break a seal between the formed object 700 and each of the one or more cores 108 such that the one or more cores 108 do not remain within the formed object 700 once it has been ejected from the container 110.

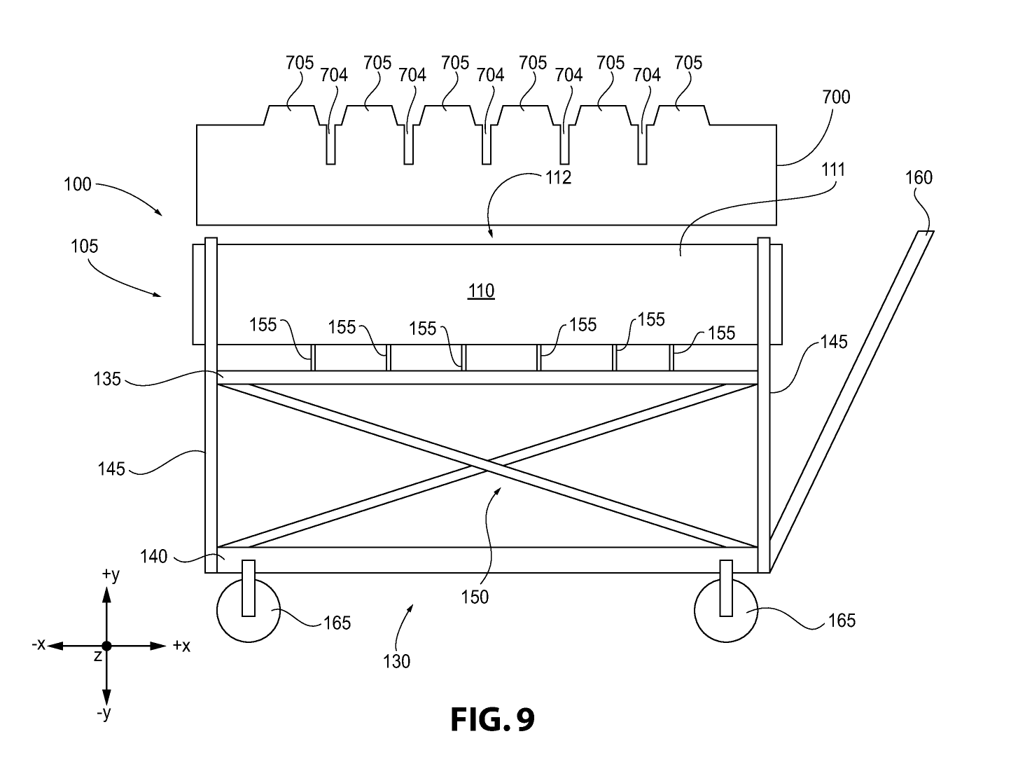

Once the extension device 150 has reached the extended position (e.g., a maximum amount the extension device 150 can extend), the lower platform 135, the one or more pins 155, and/or the base 115 (FIG. 7) of the container 110 may push the formed object 700 a distance sufficient enough to allow the formed object 700 to be fully removed from the container 110, as depicted in FIG. 9. The formed object 700 may be removable by one or more users. That is, the portable molding apparatus 100 may allow for a single user to remove the formed object 700 therefrom without assistance, if necessary. However, a plurality of users can also remove the formed object 700 from the portable molding apparatus 100 as well.

As a result of the formed object 700 being removed from the container 110 of the portable molding apparatus 100, the portable molding apparatus 100 may be returned to a state for forming additional formed objects such that the process described with respect to FIGS. 4-9 is repeated. As such, the extension device 150 may be retracted to move the lower platform 135, the one or more pins 155, and/or the base of the container 110 downward (e.g., in the −y direction of the coordinate axes of FIG. 9) such that the cavity 112 (FIG. 2) is emptied and ready to receive additional material, as described herein.

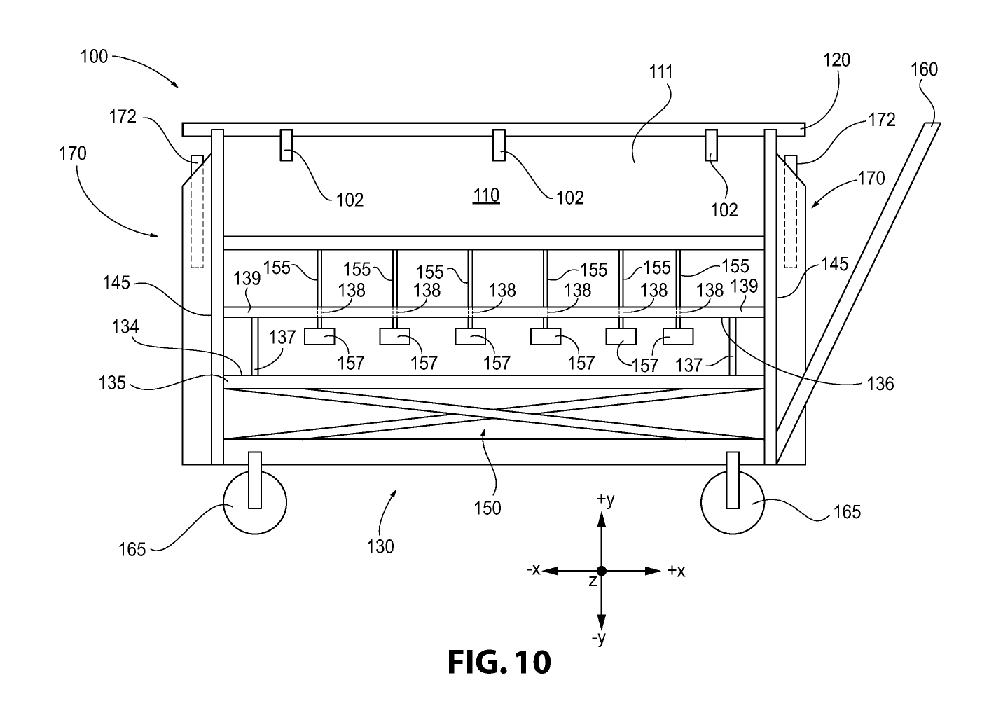

Referring to FIG. 10, another embodiment of the portable molding apparatus 100 is depicted. In the embodiment depicted in FIG. 10, the portable molding apparatus 100 includes one or more lid removal assist devices 170 positioned at the front and/or rear of the portable molding apparatus 100 and coupled to walls of the plurality of walls 111. Further, in the embodiment depicted in FIG. 10, each of the pins 155 include a retention member 157 positioned at the bottom of the pins 155. The lid removal assist devices 170 may each include an engagement member 172 that is movable with respect to the container 110 in the vertical direction (i.e., in the y-direction of the coordinate axes of FIG. 10). In embodiments, the engagement members 172 are repositionable between a retracted position, as shown in FIG. 10, in which the engagement members 172 are spaced apart from the lid 120, and an engaged position, in which the engagement members 172 engage and contact the lid 120, as described in greater detail herein. The engagement members 172 may be hydraulically, pneumatically, or mechanically actuated to move between the retracted position and the engaged position. In some embodiments, the engagement members 172 may be coupled to the handle 160, such that a user may move the engagement members 172 between the retracted position and the engaged position by moving the handle 160.

The retention members 157 are positioned at the bottom of the pins 155 and are generally sized to be larger than the pins 155. In the embodiment depicted in FIG. 10, the lower portion 130 of the portable molding apparatus 100 includes an upper platform 139 that is positioned above the lower platform 135. In embodiments, the upper platform 139 is coupled to the lower platform 135, such as by one or more vertical supports 137 that extend between the upper platform 139 and the lower platform 135. The upper platform 139 defines one or more apertures 138 extending through the upper platform 139, and each of the one or more apertures 138 correspond to a pin 155. The pins 155 generally extend through the apertures 138 of the upper platform 139, and terminate at the retention members 157. The apertures 138 of the upper platform 139 are sized such that a circumference of the apertures is smaller than a perimeter the retention members 157 (evaluated in the x-direction and/or the z-direction of the coordinate axes of FIG. 10), such that the retention members 157 may not pass through the apertures 138, while the pins 155 may move freely through the apertures 138 in the vertical direction (i.e., in the y-direction of the coordinate axes of FIG. 10). In this way, the retention members 157 are captured between the upper platform 139 and the lower platform 135.

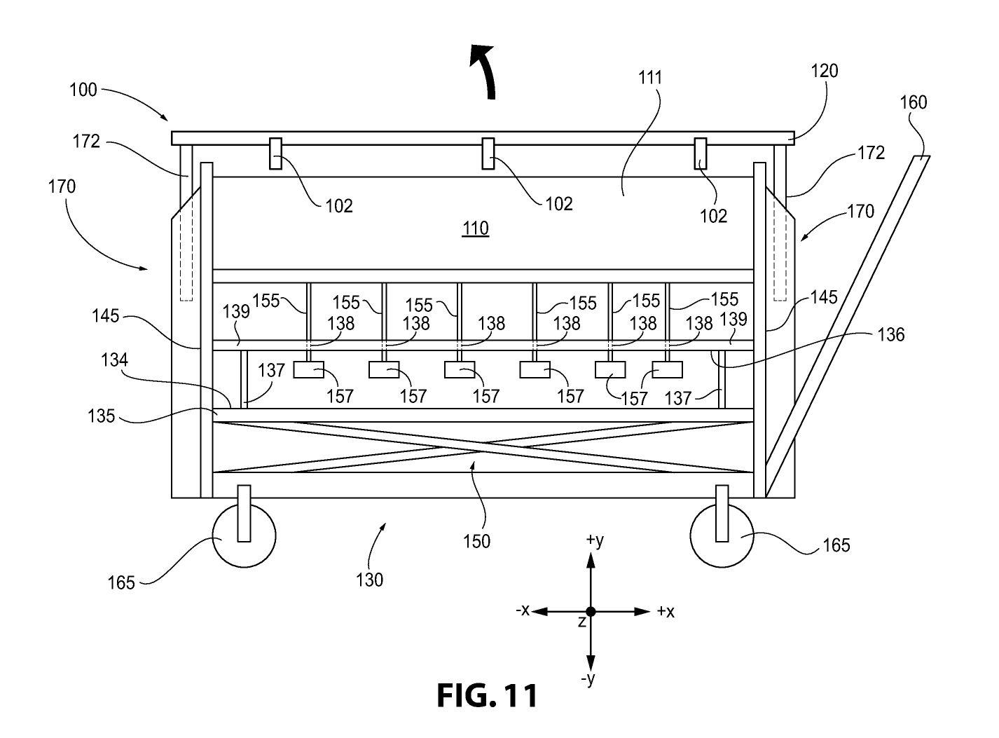

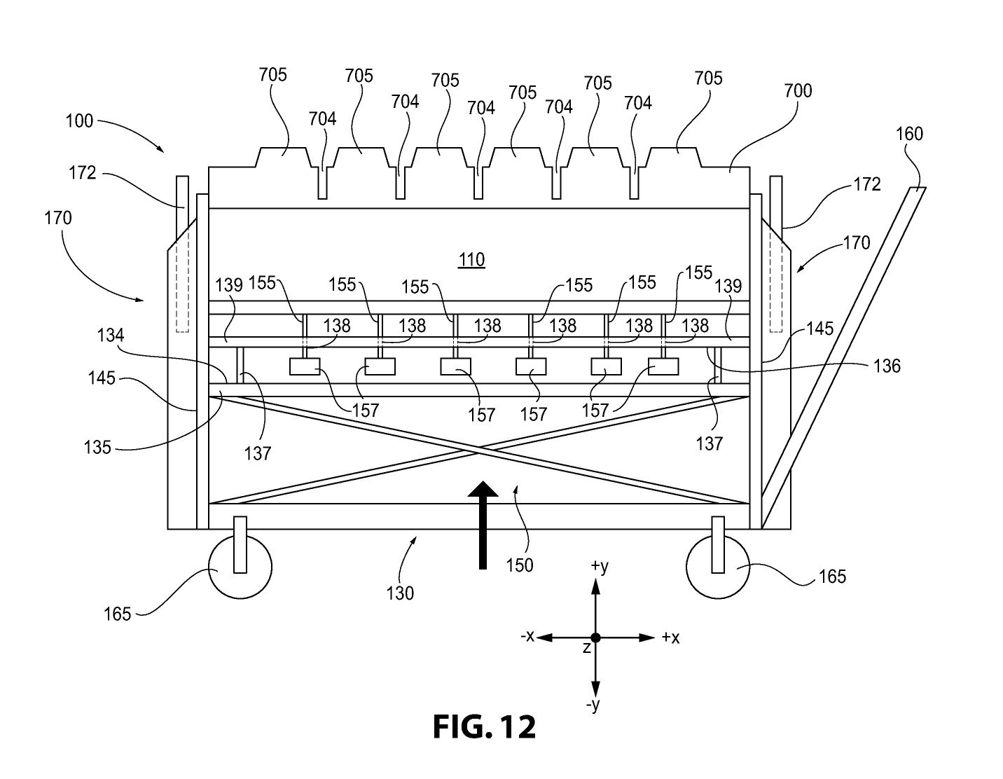

Referring to FIG. 11, a side view of the portable molding apparatus 100 is depicted showing the engagement members 172 of the lid removal assist devices 170 in the extended position and engaged with the lid 120. In the extended position, the engagement members 172 apply an upward force (i.e., in the y-direction of the coordinate axes of FIG. 11) to the lid 120, which may assist in separating the lid 120 from a formed object 700 (FIG. 9) positioned within the cavity 112 (FIG. 2) of the container 110.

Like the embodiment described above with respect to FIGS. 4-9, in the embodiment shown in FIG. 11, the formed object 700 may be removed from the container 110 by the movement of the extension device 150 to an extended position. In the embodiment shown in FIG. 11, as the extension device 150 moves to the extended position, an upper surface 134 of the lower platform 135 contacts the retention members 157, moving both the retention members 157 and the pins 155 upward in the vertical direction, which causes the base 115 (FIG. 7) and/or the cores 108 (FIG. 2) to move upward in the vertical direction.

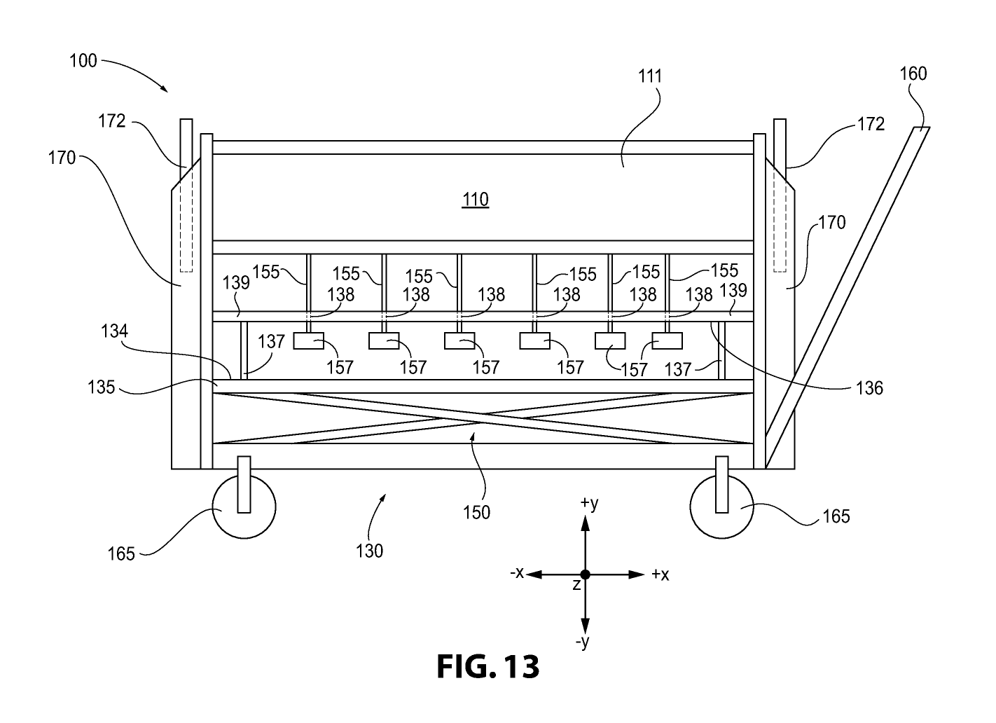

Referring to FIG. 13, when the extension device 150 is returned to the retracted position, the extension device 150 moves the lower platform 135 downward in the vertical direction. As the vertical supports 137 couple the lower platform 135 to the upper platform 139, when the lower platform 135 moves downward, the upper platform 139 moves downward as well. As the upper platform 139 moves downward, a lower surface 136 of the upper platform 139 contacts and engages the retention members 157 and moves the retention members 157, along with the pins 155 coupled to the retention members 157 downward in the vertical direction (i.e., in the −y-direction of the coordinate axes of FIG. 13). As the pins 155 move downward in the vertical direction, the base 115 (FIG. 7) and/or the cores 108 (FIG. 2) coupled to the pins 155 are moved downward in the vertical direction. In this way, the extension device 150 may move the base 115 (FIG. 7) and/or the cores 108 (FIG. 2) back to an initial position ready for the formation of another block when the extension device 150 is moved from the extended position back into the retracted position, as shown in FIG. 13.

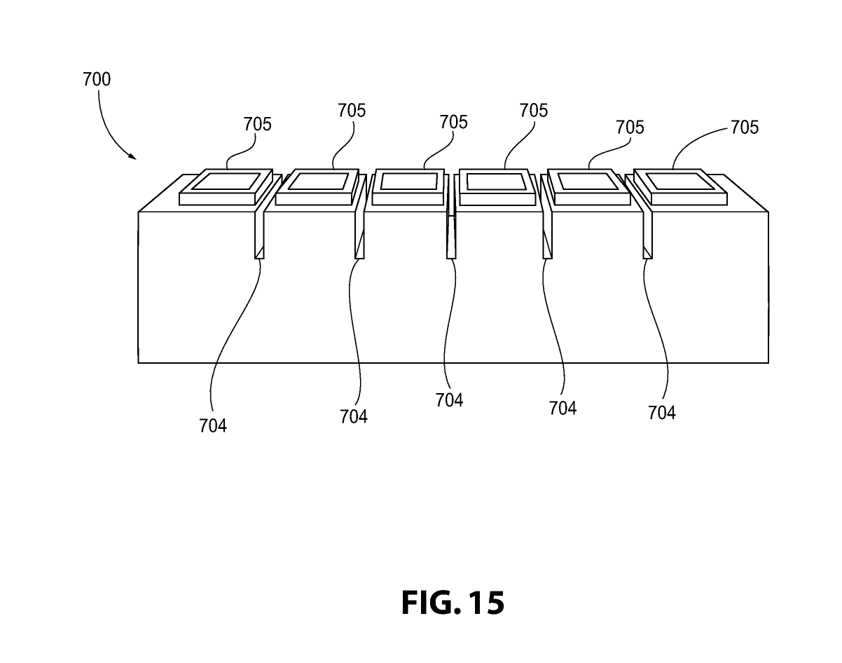

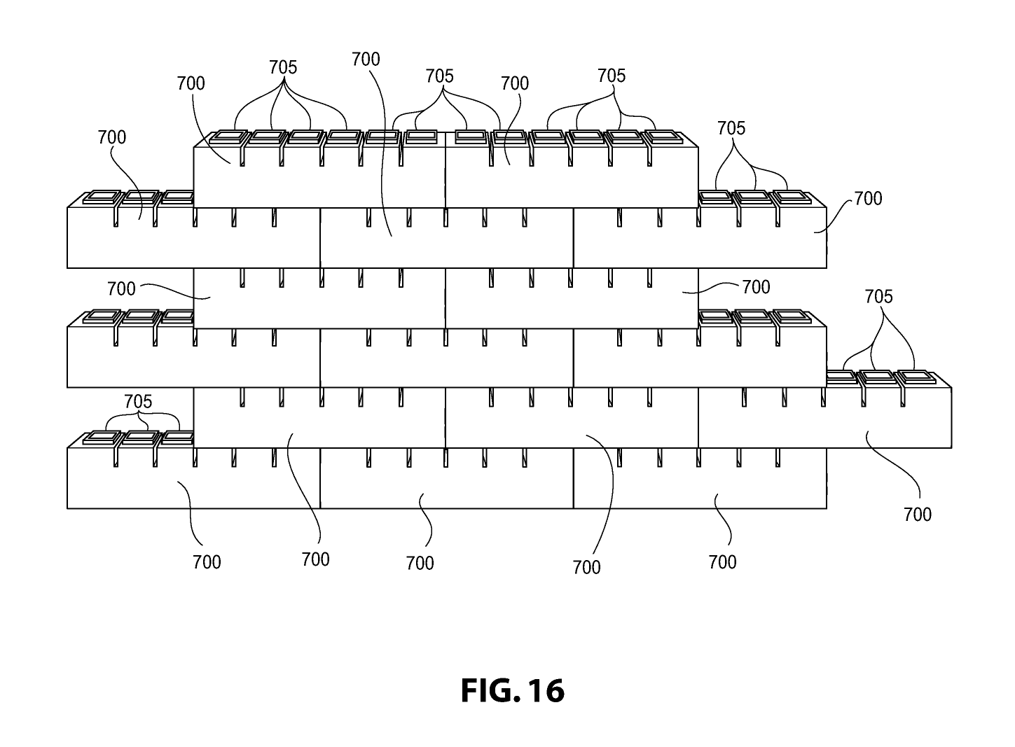

The resulting formed object 700 that is formed from the processes described herein is depicted in FIG. 15. While not limited by this disclosure, the resulting block includes a plurality of connective components 705 that are formed as a result of shaping from the various surface features present in the container 110 (FIG. 1). In embodiments, the connective components may generally correspond to and may be formed by the apertures 122 of the lid 120 (FIG. 3A). The connective components 705 may allow each formed object 700 to be coupled to other connective components present in other formed objects such that the formed objects are coupled together as shown in FIG. 16. For example, connective components 705 of one formed object 700 may be configured to be inserted within voids of another formed object, thereby coupling the formed objects 700 together. Furthermore, the resulting formed object 700 may include one or more recesses 704 extending downward into the formed object 700. The recesses 704 may generally correspond with and be formed by the fins 124 of the lid 120 (FIG. 3A). The one or more recesses 704 may reduce the overall weight of the formed object 700 as compared to objects not including recesses, thereby assisting in the transportability of the formed object 700.

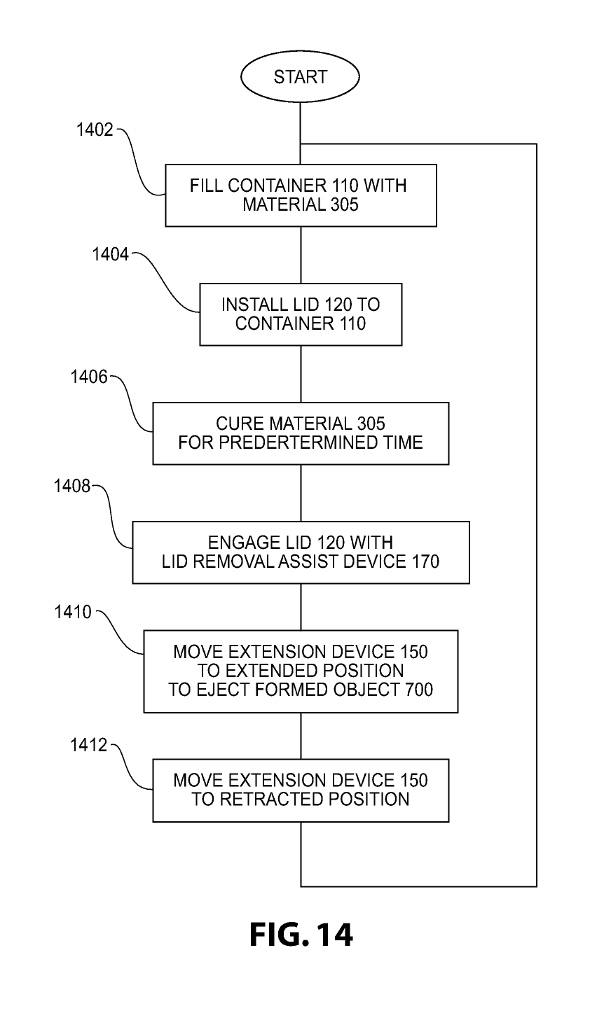

Referring to FIG. 14, an example method for forming a formed object 700 is depicted. In a first step 1402, the container 110 of the portable molding apparatus 100 is filled with a material 305. Once the container 110 is filled with material 305, as detailed above, the lid 120 is installed to the container 110 at step 1404. Once the lid 120 is positioned over the container, at step 1406, the material 305 is cured within the container 110 for a predetermined time. As described above, the predetermined time may correspond to the amount of time to cure the material 305 into a formed object 700. At step 1408, the lid removal assist device 170 optionally engages the lid 120 to remove the lid 120 from the container 110. In embodiments where the portable molding apparatus 100 does not include the lid removal assist device 170, the lid 120 may be manually removed from the container 110. At step 1410, the extension device 150 is moved from the retracted position to the extended position to eject the formed object 700 from the container 110. As described above, the extension device 150 may engage the pins 155 and the cores 108 and/or the base 115 to eject the formed object 700 from the container 110. At step 1412, the extension device 150 is moved to back to the retracted position, so that the portable molding apparatus 100 is ready to form another formed object 700. As described above, when the extension device 150 is moved back to the retracted position, in some embodiments the extension device 150 may engage the retention members 157 through the upper platform 139, moving the pins 155 and the cores 108 and/or the base 115 downward, so that the portable molding apparatus 100 is ready to form another formed object 700.

It should now be understood that the portable molding apparatuses described herein can be easily transported to a desired location, such as a construction site or the like without the need for multiple individuals to assist in transport, use of large machinery, and/or the like. Since the portable apparatus described herein is easily transported to a desired location, the objects formed by the portable apparatus can be made on site, which reduces difficulties associated with forming objects at a central location and shipping the objects to the desired location. Furthermore, it should be understood that portable molding apparatuses described herein include extension devices and/or lid removal assist devices that operate to assist with the removal of a formed object from the portable molding apparatuses, such that the portable molding apparatuses may be operated by a single user.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A portable molding apparatus comprising:
a lower portion comprising:
an extension device that is movable between an extended position and a retracted position; and
a platform coupled to the extension device;
an upper portion positioned above the lower portion, the upper portion comprising:
a base;
a plurality of walls extending upward from the base, the plurality of walls defining a cavity bounded by the plurality of walls and the base; and
a lid positioned over the cavity;
a core positioned within the cavity defined by the plurality of walls; and
a pin coupled to the core and extending downward from the core through the base, wherein the pin is spaced apart from the platform when the extension device is in the retracted position and the pin is engaged with the platform when the extension device is in the extended position.

2. The portable molding apparatus of claim 1, wherein the pin is coupled to the base.

3. The portable molding apparatus of claim 2, wherein the platform is a lower platform and the lower portion further comprises an upper platform positioned above the lower platform.

4. The portable molding apparatus of claim 3, further comprising a retention member coupled to the pin and positioned between the upper platform and the lower platform.

5. The portable molding apparatus of claim 4, wherein the upper platform defines an aperture extending through the upper platform, and the pin is positioned within the aperture, and wherein the aperture comprises a circumference that is smaller than a perimeter of the retention member.

6. The portable molding apparatus of claim 1, further comprising a lid removal assist device coupled to one of the plurality of walls, wherein the lid removal assist device is movable between an engaged position, in which the lid removal assist device engages the lid, and a retracted position, in which the lid removal assist device is spaced apart from the lid.

7. The portable molding apparatus of claim 1, wherein the lower portion further comprises wheels.

8. The portable molding apparatus of claim 1, wherein the lid comprises an aperture positioned over the core.

9. The portable molding apparatus of claim 1, wherein the lid comprises a fin extending downward from the lid.

10. A portable molding apparatus comprising:
a lower portion comprising:
an extension device that is movable between an extended position and a retracted position; and
a platform coupled to the extension device;
an upper portion positioned above the lower portion, the upper portion comprising:
a base; and
a plurality of walls extending upward from the base, the plurality of walls defining a cavity bounded by the plurality of walls and the base, wherein the base is engaged with the platform when the extension device is in the extended position, and the base is disengaged from the platform when the extension device is in the retracted position.

11. The portable molding apparatus of claim 10, further comprising a plurality of pins coupled to the base, wherein the base is engaged with the platform through the plurality of pins when the extension device is in the extended position.

12. The portable molding apparatus of claim 11, further comprising a plurality of retention members coupled to each of the plurality of pins, wherein the base is engaged with the platform through the plurality of pins and the plurality of retention members when the extension device is in the extended position.

13. The portable molding apparatus of claim 10, further comprising:
a core positioned within the cavity; and
a pin coupled to the core.

14. A portable molding apparatus comprising:
a lower portion comprising:
an extension device that is movable between an extended position and a retracted position;
a lower platform coupled to the extension device; and
an upper platform positioned above the lower platform and coupled to the lower platform;
an upper portion positioned above the lower portion, the upper portion comprising:
a base;
a plurality of walls extending upward from the base, the plurality of walls defining a cavity bounded by the plurality of walls and the base; and
a lid positioned over the cavity;
a core positioned within the cavity defined by the plurality of walls;
a pin extending downward through from the base; and
a retention member coupled to the pin and positioned between the lower platform and the upper platform, wherein the retention member is spaced apart from the lower platform when the extension device is in the retracted position and the retention member is engaged with the lower platform when the extension device is in the extended position.

15. The portable molding apparatus of claim 14, wherein the upper platform defines an aperture and the pin extends through the aperture of the upper platform.

16. The portable molding apparatus of claim 15, wherein a perimeter the retention member is larger than a circumference of the aperture.

17. The portable molding apparatus of claim 14, further comprising a lid removal assist device coupled to one of the plurality of walls, wherein the lid removal assist device is movable between an engaged position, in which the lid removal assist device engages the lid, and a retracted position, in which the lid removal assist device is spaced apart from the lid.

18. The portable molding apparatus of claim 14, wherein the lid defines an aperture extending through the lid.

19. The portable molding apparatus of claim 14, wherein the lid comprises a fin extending downward from the lid.

20. The portable molding apparatus of claim 14, wherein the pin is coupled to the base.
